(19) United States
(12) Patent Application Publication
(10) Pub. No.: US 2014/0036668 A1
(43) Pub. Date: Feb. 6, 2014

(54) METHOD AND APPARATUS FOR CONGESTION CONTROL DURING A COMBINED REGISTRATION

(71) Applicant: Renesas Mobile Corporation, Tokyo (JP)

(72) Inventor: Marko Tapani Niemi, Oulu (FI)

(73) Assignee: Renesas Mobile Corporation, Tokyo (JP)

(21) Appl. No.: 13/960,143

(22) Filed: Aug. 6, 2013

Related U.S. Application Data
(60) Provisional application No. 61/680,027, filed on Aug. 6, 2012.

(51) Int. Cl. H04L 12/841

(52) U.S. Cl. CPC H04L 47/28
USPC 370/230

(57) ABSTRACT

A method, apparatus and computer program product are provided to facilitate the combined registration in both the PS domain and the CS domain. In response to an initial request for a combined registration for a PS domain and a CS domain, a method may receive an indication that the registration for one of the domains is successful but that the registration for the other domain is unsuccessful. The method may prevent, in response to the indication that the registration for one domain is successful but that the registration for the other domain is unsuccessful, another request for the combined registration for the PS domain and the CS domain for a predetermined period of time following the initial request. A corresponding apparatus and computer program product are also provided.

### CROSS REFERENCE TO RELATED APPLICATION

This application is a non-provisional of and claims priority to U.S. Provisional Application No. 61/680,027, filed Aug. 6, 2012, the entire contents of which are herein incorporated by reference.

### TECHNOLOGICAL FIELD

An example embodiment of the present invention relates generally to a combined registration in the packet switched (PS) and circuit switched (CS) domains and, more particularly, to congestion control during the combined registration.

### BACKGROUND

In some instances, a mobile terminal may request a combined registration in both the PS domain and the CS domain. For example, for global multi-media mobility (GMM) or mobility management (MM), a mobile terminal, such as a mobile telephone, a smartphone, a tablet computer, a laptop computer or the like, may initiate a combined parallel registration for both the PS domain and the CS domain. In some instances, particularly for lower priority requests, the network may determine that at least one of the domains is congested such that the registration for the respective domain is unsuccessful. In this regard, the network may detect GMM or MM signaling congestion and perform non-access stratum (NAS) level mobility management congestion control. PS domain NAS level mobility management congestion control may consist of general NAS level mobility management congestion control and subscribed access point name (APN) based congestion control. CS domain NAS level mobility management congestion control may consist of general NAS level mobility management congestion control.

In an instance in which the PS domain is not congested, but the CS domain is congested, the network may indicate to the mobile terminal, in response to a request for a combined registration for the PS and CS domains, that the registration is successful for the PS domain only, but may indicate that the registration for the CS domain is restricted or unsuccessful due to congestion in the CS domain. In this regard, the network may provide a cause code to the mobile terminal indicating that the registration to the CS domain is restricted due to congestion. The mobile terminal may then repeatedly regenerate the request for a combined registration for both the PS domain and the CS domain in an effort to obtain a successful registration for both the PS domain and the CS domain. However, the registration procedure that is regenerated by the mobile terminal initiates a registration procedure for both the PS domain and the CS domain even though the registration for the PS domain was already successful, thereby disadvantageously increasing the PS signaling and congesting the PS domain as a result of the registration failure in the CS domain.

The mobile terminal may regenerate the registration procedure up to a predefined number of times, such as up to five times before initiating a timer that then prevents the mobile terminal from again requesting the combined registration until the timer has expired. However, prior to this point, the repeated regeneration of the registration procedure may disadvantageously increase the PS signaling and further congest the PS domain due to a failure, not within the PS domain, but within the CS domain.

### BRIEF SUMMARY

A method, apparatus and computer program product are provided according to one embodiment of the present invention in order to facilitate the combined registration in both the PS domain and the CS domain. In this regard, the method, apparatus and computer program product of an example embodiment may respond to an indication that the registration in one of the domains, such as the PS domain, is successful, but that the registration in the other domain, such as the CS domain, is unsuccessful in a manner that controls the regeneration of the registration request so as not to increase the signaling in and further congest the domain in which the registration was successful to such a degree as in the past. Thus, the method, apparatus and computer program product of an example embodiment may ensure that congestion in one domain does not undesirably increase congestion in another domain as a result of the combined registration process. Moreover, the method, apparatus and computer program product of an example embodiment are backwards compatible so as to work with prior models of mobile terminals.

In one embodiment, a method is provided that, in response to an initial request for a combined registration for a PS domain and a CS domain, receives an indication that the registration for one of the domains is successful but that the registration for the other domain is unsuccessful. The method of this embodiment also prevents, in response to the indication that the registration for one domain is successful but that the registration for the other domain is unsuccessful, another request for the combined registration for the PS domain and the CS domain for a predetermined period of time following the initial request.

In another embodiment, an apparatus is provided that includes at least one processor and at least one memory including computer program code with the memory and the computer program code configured to, with the at least one processor, cause the apparatus at least to receive, in response to an initial request for a combined registration for a PS domain and a CS domain, an indication that the registration for one of the domains is successful but that the registration for the other domain is unsuccessful. The at least one memory and computer program code of this embodiment are also configured to, with the at least one processor, cause the apparatus to prevent, in response to receipt of the indication that the registration for one domain is successful but that the registration for the other domain is unsuccessful, another request for the combined registration for the PS domain and the CS domain for a predetermined period of time following the initial request.

In a further embodiment, a computer program product is provided that includes at least one non-transitory computer-readable storage medium having computer-readable program instructions stored therein with the computer-readable program instructions including program instructions configured to receive, in response to an initial request for a combined registration for a PS domain and a CS domain, an indication that the registration for one of the domains is successful but that the registration for the other domain is unsuccessful. The computer-readable program instructions of this embodiment also include program instructions configured to prevent, in response to receipt of the indication that the registration for one domain is successful but that the registration for the other domain is unsuccessful, another request for the combined registration for the PS domain and the CS domain for a predetermined period of time following the initial request.

In yet another embodiment, an apparatus is provided that includes means for receiving, in response to an initial request for a combined registration for a PS domain and a CS domain, an indication that the registration for one of the domains is successful but that the registration for the other domain is unsuccessful. The apparatus of this embodiment also includes means for preventing, in response to receipt of the indication that the registration for one domain is successful but that the registration for the other domain is unsuccessful, another request for the combined registration for the PS domain and the CS domain for a predetermined period of time following the initial request.

In one embodiment, a method is provided that includes receiving an initial request for a combined registration for a PS domain and a CS domain and determining that the registration for one of the domains is successful but that the registration for the other domain is unsuccessful. The method of this embodiment also causes an indication to be provided that: (i) the registration for one of the domains is successful, but that the registration for the other domain is unsuccessful, and (ii) a timer is to be actuated so as to prevent another request for the combined registration for the PS domain and the CS domain for a predetermined period of time following the initial request.

In another embodiment, an apparatus is provided that includes at least one processor and at least one memory including computer program code with the memory and the computer program code configured to, with the at least one processor, cause the apparatus at least to receive an initial request for a combined registration for a PS domain and a CS domain and to determine that the registration for one of the domains is successful, but that the registration for the other domain is unsuccessful. The at least one memory and computer program code of this embodiment are also configured to, with the at least one processor, cause the apparatus to cause an indication to be provided that: (i) the registration for one of the domains is successful, but that the registration for the other domain is unsuccessful, and (ii) a timer is to be actuated so as to prevent another request for the combined registration for the PS domain and the CS domain for a predetermined period of time following the initial request.

In a further embodiment, a computer program product is provided and includes at least one non-transitory computer-readable storage medium having computer-readable program instructions stored therein with the computer-readable program instructions including program instructions configured to receive an initial request for a combined registration for a PS domain and a CS domain and to determine that the registration for one of the domains is successful, but that the registration for the other domain is unsuccessful. The computer-readable program instructions of this embodiment also include program instructions configured to cause an indication to be provided that: (i) the registration for one of the domains is successful, but that the registration for the other domain is unsuccessful, and (ii) a timer is to be actuated so as to prevent another request for the combined registration for the PS domain and the CS domain for a predetermined period of time following the initial request.

In yet another embodiment, an apparatus is provided that includes means for receiving an initial request for a combined registration for a PS domain and a CS domain and means for determining that the registration for one of the domains is successful, but that the registration for the other domain is unsuccessful. The apparatus of this embodiment also includes means for causing an indication to be provided that: (i) the registration for one of the domains is successful, but that the registration for the other domain is unsuccessful, and (ii) a timer is to be actuated so as to prevent another request for the combined registration for the PS domain and the CS domain for a predetermined period of time following the initial request.

### BRIEF DESCRIPTION OF THE DRAWINGS

Having thus described certain example embodiments of the present invention in general terms, reference will hereinafter be made to the accompanying drawings, which are not necessarily drawn to scale, and wherein:

FIG. 1 is a schematic representation of a system that may support the combined registration for the PS domain and the CS domain;

FIG. 2 is a block diagram of an apparatus that may be embodied by a mobile terminal or a network entity, such as an access point, and that may be specifically configured in accordance with an example embodiment of the present invention;

FIG. 3 is a flowchart illustrating operations performed by an apparatus embodied by a mobile terminal and specifically configured in accordance with an example embodiment of the present invention; and

FIG. 4 is a block diagram of the operations performed by an apparatus embodied by a network entity, such as an access point, and specifically configured in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

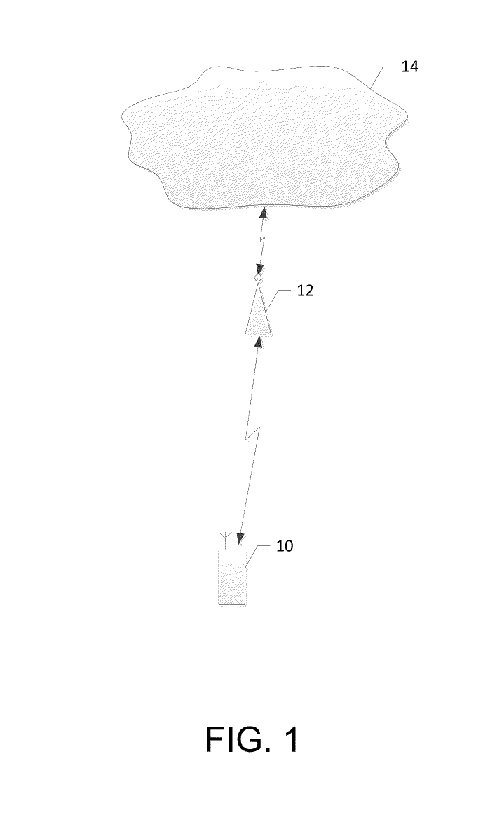

A method, apparatus and computer program product are provided in accordance with an example embodiment in order to provide for the combined registration in both the PS domain and the CS domain in a manner that does not unnecessarily increase the congestion in one of the domains in which the registration is successful in response to an indication that the registration was unsuccessful in the other domain. Although the method, apparatus and computer program product may be implemented in a variety of different system architectures, one example of a system that may be specifically configured in order to implement an example embodiment of the present invention is shown in FIG. 1.

Referring now to FIG. 1, a system that supports communications between a plurality of mobile terminals 10 (one of which is illustrated by way of example) and a network 14, such as an 802.11 network, a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network, via an access point 12 is shown. Various types of mobile terminals may be employed including, for example, mobile communication devices such as, for example, mobile telephones, smartphones, personal digital assistants (PDAs), pagers, laptop computers, tablet computers or any of numerous other hand held or portable communication devices, computation devices, content generation devices, content consumption devices, or combinations thereof. Regardless of the type of mobile terminal, the mobile terminal may communicate with the network via an access point, such as a base station, a Node B, an evolved Node B (eNB), a relay node or other type of access point.

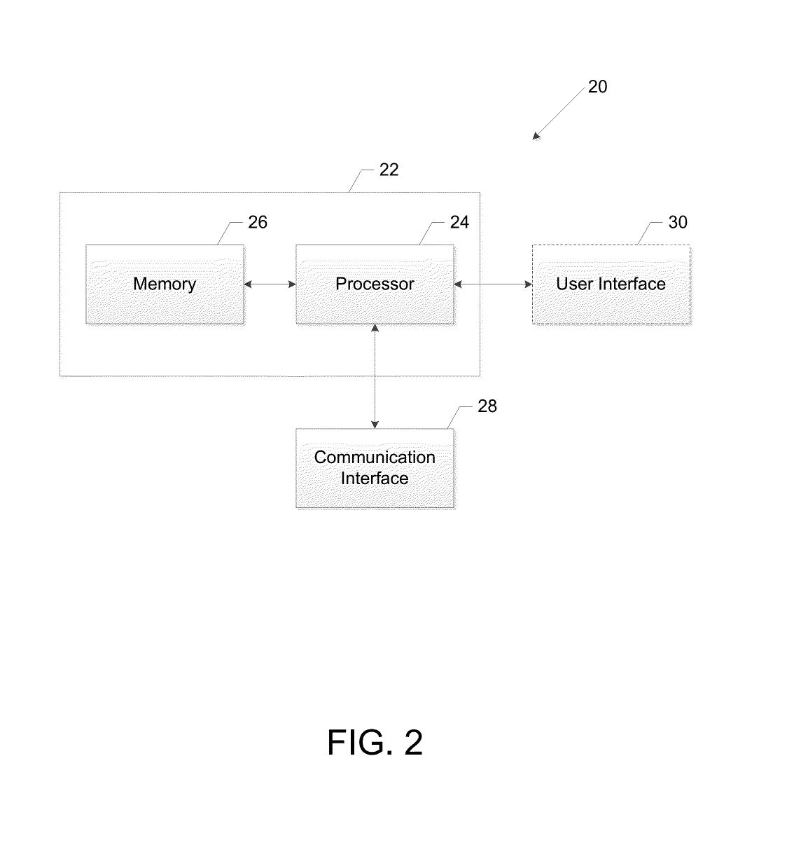

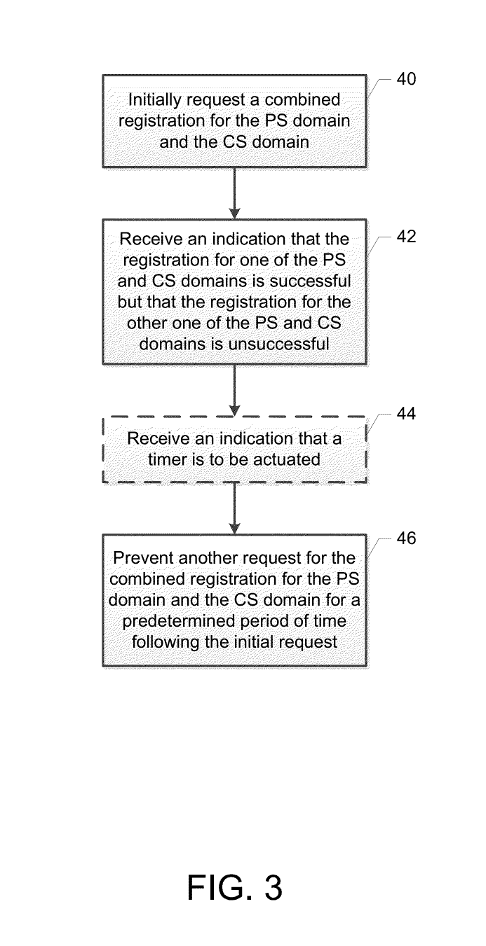

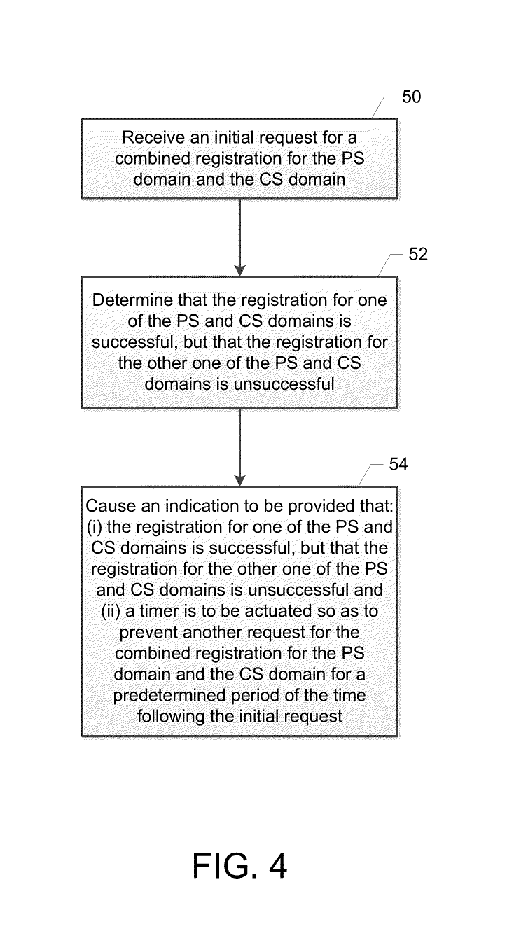

The mobile terminal 10 and a network entity, such as the access point 12, may each embody or otherwise be associated with an apparatus 20 that is generally depicted in FIG. 2 and that may be configured to perform various operations in accordance with an example embodiment of the present invention as described below, such as in conjunction with FIG. 3 from the perspective of the mobile terminal and FIG. 4 from the perspective of a network entity, such as the access point. However, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with a processing system including, for example, processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a communication interface 28 and, in some cases in which the apparatus is embodied by the mobile terminal 10, a user interface 30. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of mobile terminal or the access point.

The user interface 30 (if implemented in embodiments of the apparatus 20 embodied by the mobile terminal 10) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the station by receiving user input and providing output.

The communication interface 28 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the access point 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

As noted above, FIGS. 3 and 4 are flowcharts illustrating the operations performed by a method, apparatus and computer program product, such as apparatus 20 of FIG. 2, from the perspective of the mobile terminal 10 and a network entity, such as the access point 12, respectively, in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 of the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g., processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included as shown, for example by the dashed lines in FIG. 3. It should be appreciated that each of the modifications, optional additions or amplifications below may be included with the operations above either alone or in combination with any others among the features described herein.

Referring now to FIG. 3, the operations performed by a method, apparatus and computer program product of an example embodiment are illustrated from the perspective of an apparatus 20 that may be embodied by or otherwise associated with a mobile terminal 10. In an instance in which a mobile terminal desires to have access to and utilize both the PS domain and the CS domain, such as in conjunction with GMM or MM or in instances in which the PS domain is utilized to access CS services, e.g. short message service (SMS) or CS speech services, the apparatus may include means, such as the processing circuitry 22, the processor 24, the communications interface 28 or the like, for causing an initial request for a combined registration for both the PS domain and the CS domain to be issued to the network 14, such as to the access point 12 with which the mobile terminal is in communication. See block 40 of FIG. 3. In this regard, the initial request for a combined registration for the PS domain and the CS domain is a request that is initiated by the mobile terminal that is not in response to a prior request for a combined registration in the PS domain and the CS domain that has been successful, if at all, for only one of the domains, such as the PS domain, but not for the other domain, such as the CS domain. As such, the initial request for combined registration is not a regenerated registration request that follows an indication that a prior request for one of the domains, such as the PS domain, was successful, but that the registration for the other domain, such as the CS domain, was unsuccessful.

In response to the initial request for the combined registration for the PS domain and the CS domain, the apparatus 20 embodied by the mobile terminal 10 may include means, such as the processing circuitry 22, the processor 24, the communications interface 28 or the like, for receiving an indication that the registration for one of the domains, such as the PS domain, is successful but that the registration for the other domain, such as the CS domain, is unsuccessful. See block 42 of FIG. 3. In other words, the apparatus embodied by the mobile terminal may receive an indication that the registration is successful for only one of the domains, e.g., the PS domain registration is successful and the CS domain registration is unsuccessful. The indication that the registration for one of the domains, e.g., the PS domain, is successful may be provided via an accept message, e.g. ATTACH ACCEPT, RAU ACCEPT, TAU ACCEPT, etc. In this regard, the mobile terminal may receive the indication that the registration for one domain is successful, but that the registration for the other domain is unsuccessful from the network 14, such as from the access point 12 with which the mobile terminal is in communication. The registration for one of the domains, such as the CS domain, may be unsuccessful due to congestion within the respective domain. In this regard, requests that are considered to be of a lower priority by the network may more frequently be unsuccessful as a result of the network congestion due to the network's servicing of other requests that are considered to be a higher priority.

In addition to receiving the indication that the registration for one domain, such as the PS domain, is successful but that the registration for the other domain, such as the CS domain, is unsuccessful, the apparatus 20 embodied by the mobile terminal 10 of one embodiment may include means, such as the processing circuitry 22, the processor 24, the communications interface 28 or the like, for also receiving an indication as to the cause of the unsuccessful registration, such as by receiving an indication that the registration for one of the domains, such as the CS domain, is unsuccessful as a result of congestion within the respective domain. Thus, the indication that is received by the mobile terminal may not only indicate that the registration for one of the domains is unsuccessful, but may provide a cause for the unsuccessful registration which, in some instances, may be attributable to the congestion in the respective domain.

As shown in block 46 of FIG. 3, the apparatus 20 embodied by the mobile terminal 10 may also include means, such as the processing circuitry 22, the processor 24, the communications interface 28 or the like, for preventing another request for the combined registration for the PS domain and the CS domain for a predetermined period of time following the initial request in an instance in which an indication is received by the mobile terminal that the registration for one of the domains is successful but that the registration for the other domain is unsuccessful. By preventing another request for the combined registration for the PS domain and the CS domain for a predetermined period of time following the receipt of an indication, triggered by the initial request, that the registration for one domain is successful, but that the registration for the other domain is unsuccessful, the mobile terminal may be prevented from consuming additional resources within the domain in which the registration was successful in an effort to successfully register with the other domain for which the registration was unsuccessful.

The apparatus 20 embodied by the mobile terminal 10 may measure the predetermined period of time during which another request is prevented in various manners including, for example, with a timer. In this regard, the processing circuitry 22, the processor 24 or the like, may include a timer that is configured to measure the predetermined period of time. In this embodiment, the apparatus embodied by the mobile terminal may prevent another request by including means, such as the processing circuitry, the processor, the communications interface 28 or the like, for actuating the timer that measures the predetermined period of time in response to the receipt of the indication that the registration for one of the domains is successful but that the registration for the other domain is unsuccessful. In one embodiment, the apparatus embodied by the mobile terminal may also include means, such as the processing circuitry, the processor, the communications interface or the like, for receiving an indication, such as a T3246 information element (IE) from the network 10 and, more particularly, from a network entity, such as the access point 12, that the timer is to be actuated. See block 44 of FIG. 3. In response to the receipt of the indication that the timer is to be actuated, the apparatus embodied by the mobile terminal, such as the processing circuitry, the processor or the like, may actuate the timer to measure the predetermined period of time during which the request for the combined registration for the PS domain and the CS domain is prevented.

In one embodiment, the indication that the timer is to be actuated may be received in conjunction with the indication that the registration for one of the domains is successful but that the registration for the other domain is unsuccessful. In this regard, the mobile terminal 10 may receive a message that includes both the indication that the registration for one of the domains is successful but that the registration for the other domain is unsuccessful as well as an indication that the timer is to be actuated. In one embodiment, the indication that the timer is to be actuated also includes a value for the timer that defines the predetermined period of time. As such, the network 14, such as a network entity, e.g., the access point 12, may define the period of time during which the mobile terminal is prevented from issuing another request for the combined registration for the PS domain and the CS domain. The message that includes the indication that the registration for one of the domains is successful but that the registration for the other domain is unsuccessful as well as the indication that the timer is to be actuated may also include an indication as to the cause for the unsuccessful registration, such as an indication that the registration for one of the domains is unsuccessful as a result of congestion within the respective domain.

Thus, the mobile terminal 10 of one embodiment may avoid consumption of resources in a domain in which registration was successful in an effort to successfully register in another domain in which the registration was initially unsuccessful, such as due to congestion. In this regard, in response to a request for the combined registration in the PS domain and the CS domain, the mobile terminal may receive an indication that the registration in one domain, such as the PS domain, is successful, but that the registration in the other domain, such as the CS domain, is unsuccessful and, in some embodiments, may receive an indication as to the cause of the unsuccessful registration and/or an indication that a timer is to be actuated. In response to receipt of the indication that the registration in one domain, such as the PS domain, is successful, but that the registration in the other domain, such as the CS domain, is unsuccessful, the mobile terminal may prevent another request for the combined registration for the PS domain and the CS domain, following the initial request, for a predetermined period of time, such as measured by the timer. As such, the mobile terminal may prevent consumption of additional resources and an increase in the congestion in the domain in which the registration was successful in an effort to register in the other domain for which the registration was initially unsuccessful due to, for example, congestion.

Referring now to FIG. 4 from the perspective of a network entity, such as the access point 12, with which the mobile terminal 10 is in communication, the apparatus 20 embodied by the network entity, such as the access point, may include means, such as the processing circuitry 22, the processor 24, the communications interface 28 or the like, for receiving an initial request for a combined registration for the PS domain and the CS domain. See block 50 of FIG. 4. The apparatus embodied by the network entity, such as the access point, may also include means for determining that the registration for one of the domains, such as the PS domain, is successful, but that the registration in the other domain, such as the CS domain, is unsuccessful. See block 52. In this regard, the network entity, such as the access point, may make this determination based upon its consideration of the congestion of the PS domain and the CS domain as well as, in some embodiments, the relative priority of the request that has been provided by the mobile terminal. In other embodiments, the network entity, such as the access point, may transmit the request for the combined registration to another entity within the network 14 and may receive, in response, an indication as to whether the registration for the PS domain and the CS domain is successful for both domains, for one domain or for neither domain. In this embodiment, the receipt and the interpretation of response from another network entity as to whether the request for a combined registration for the PS domain and the CS domain and, in one embodiment, the determination that the registration for one of the domains, such as the PS domain, is successful, but that the registration for the other domain, such as the CS domain, is unsuccessful comprises a determination as set forth in block 52 of FIG. 4.

The apparatus 20 embodied by the network entity, such as the access point 12, may also include means, such as a the processing circuitry 22, the processor 24, the communications interface 28 or the like, for causing an indication to be provided to the mobile terminal 10 that the registration for one of the domains, such as the PS domain, is successful but that the registration for the other domain, such as the CS domain, is unsuccessful. See block 54 of FIG. 4. In other words, the apparatus embodied by the network entity, such as the access point, may cause an indication to be provided that the registration is successful for only one of the domains, e.g., the PS domain registration is successful and the CS domain registration is unsuccessful. The indication provided by the network entity, such as the access point, such as a T3246 IE, may also indicate that a timer is to be actuated so as to prevent another request for the combined registration for the PS domain and the CS domain for a predetermined period to time following the initial request. In this regard, the predetermined period of time may be defined by the timer. Indeed, the indication that the timer is to be actuated that is provided by the network entity, such as the access point, may include a value for the timer that defines the predetermined period of time. While the value of the timer may be predefined, the value of the timer may depend, for example, upon the level of congestion within the domain, such as the CS domain, for which the registration was unsuccessful with greater levels of congestion causing the value of the timer to be greater and lower levels of congestion causing the value of the timer to be less, e.g., the value of the timer may be proportional or otherwise vary directly in regards to the level of congestion within the respective domain.

In addition to indicating that the registration for one of the domains, such as the PS domain, is successful and that the registration for the other domain, such as the CS domain, is unsuccessful and indicating that a timer is to be actuated to measure the predetermined period of time for which another request for the combined registration for the PS domain and the CS domain is to be prevented following the initial request, the indication that is provided by the network entity, such as the access point 12, may also indicate the reason for the unsuccessful registration, such as by providing an indication that the registration for one of the domains, such as the CS domain, was unsuccessful as a result of congestion within the respective domain. Based upon the indication provided by the network entity, such as the access point, in an instance in which an initial request for a combined registration for the PS domain and the CS domain leads to the registration of one domain, such as the PS domain, being successful but the registration for the other domain, such as the CS domain, being unsuccessful, the mobile terminal 10 may be prevented from issuing another request for the combined registration for the PS domain and the CS domain for the predetermined period of time, such as defined by the timer, following the initial request. As such, the mobile terminal and the network, such as the access point, may cooperate so as to avoid repeated requests for the combined registration for the PS domain and the CS domain in an instance in which the registration for one of the domains, such as the PS domain, is successful but the registration for the other domain, such as the CS domain, is unsuccessful which would otherwise undesirably consume resources, such as signaling resources, in the domain for which the registration was successful in an effort to successfully register in the domain that was at least initially unsuccessful.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
in response to an initial request for a combined registration for a packet switched (PS) domain and a circuit switched (CS) domain, receiving an indication that the registration for one of the PS and CS domains is successful but that the registration for the other one of the PS and CS domains is unsuccessful; and
preventing, in response to the indication, another request for the combined registration for the PS domain and the CS domain for a predetermined period of time following the initial request.

2. A method according to claim 1 wherein receiving the indication that the registration for one of the PS and CS domains is successful and that the registration for the other one of the PS and CS domains is unsuccessful comprises receiving the indication that the registration for the PS domain is successful but that the registration for the CS domain is unsuccessful and receiving an indication that the registration for the CS domain is unsuccessful as a result of CS domain congestion.

3. A method according to claim 1 wherein preventing another request comprises actuating a timer that measures the predetermined period of time.

4. A method according to claim 3 further comprising receiving an indication that the timer is to be actuated.

5. A method according to claim 4 wherein the indication that the timer is to be actuated is received in conjunction with the indication that the registration for one of the PS and CS domains is successful but that the registration for the other one of the PS and CS domains is unsuccessful.

6. A method according to claim 4 wherein the indication that the timer is to be actuated includes a value for the timer that defines the predetermined period of time.

7. A computer program product comprising at least one non-transitory computer-readable storage medium having computer-readable program instructions stored therein with the computer-readable program instructions comprising program instructions configured to perform the method of claim 1.

8. An apparatus comprising:
at least one processor; and
at least one memory including computer program code, the at least one memory and the computer program code configured to, with the at least one processor, cause the apparatus at least to:
in response to an initial request for a combined registration for a packet switched (PS) domain and a circuit switched (CS) domain, receive an indication that the registration for one of the PS and CS domains is successful but that the registration for the other one of the PS and CS domains is unsuccessful; and
prevent, in response to the indication, another request for the combined registration for the PS domain and the CS domain for a predetermined period of time following the initial request.

9. An apparatus according to claim 8 wherein the at least one memory and the computer program code are configured to, with the at least one processor, cause the apparatus to receive the indication that the registration for one of the PS and CS domains is successful and that the registration for the other one of the PS and CS domains is unsuccessful by receiving the indication that the registration for the PS domain is successful but that the registration for the CS domain is unsuccessful and receiving an indication that the registration for the CS domain is unsuccessful as a result of CS domain congestion.

10. An apparatus according to claim 8 wherein the at least one memory and the computer program code are configured to, with the at least one processor, cause the apparatus to prevent another request by actuating a timer that measures the predetermined period of time.

11. An apparatus according to claim 10 the at least one memory and the computer program code are further configured to, with the at least one processor, cause the apparatus to receive an indication that the timer is to be actuated.

12. An apparatus according to claim 11 wherein the indication that the timer is to be actuated is received in conjunction with the indication that the registration for one of the PS and CS domains is successful but that the registration for the other one of the PS and CS domains is unsuccessful.

13. An apparatus according to claim 10 wherein the indication that the timer is to be actuated includes a value for the timer that defines the predetermined period of time.

14. An apparatus according to claim 8 wherein the apparatus is embodied by a mobile terminal.

15. An apparatus according to claim 8 further comprising a communication interface configured to communicate with the at least one processor.

16. A method comprising:
receiving an initial request for a combined registration for a packet switched (PS) domain and a circuit switched (CS) domain;
determining that the registration for one of the PS and CS domains is successful but that the registration for the other one of the PS and CS domains is unsuccessful; and
causing an indication to be provided that: (i) the registration for one of the PS and CS domains is successful but that the registration for the other one of the PS and CS domains is unsuccessful and (ii) a timer is to be actuated so as to prevent another request for the combined registration for the PS domain and the CS domain for a predetermined period of time following the initial request.

17. A method according to claim 16 wherein receiving the indication that the registration for one of the PS and CS domains is successful but that the registration for the other one of the PS and CS domains is unsuccessful comprises receiving the indication that the registration for the PS domain is successful but that the registration for the CS domain is unsuccessful and receiving an indication that the registration for the CS domain is unsuccessful as a result of CS domain congestion.

18. A method according to claim 16 wherein the indication that the timer is to be actuated includes a value for the timer that defines the predetermined period of time.

19. A computer program product comprising at least one non-transitory computer-readable storage medium having computer-readable program instructions stored therein with the computer-readable program instructions comprising program instructions configured to perform the method of claim 16.

20. An apparatus comprising:
at least one processor; and
at least one memory including computer program code, the at least one memory and the computer program code configured to, with the at least one processor, cause the apparatus at least to:
receive an initial request for a combined registration for a packet switched (PS) domain and a circuit switched (CS) domain;
determine that the registration for one of the PS and CS domains is successful but that the registration for the other one of the PS and CS domains is unsuccessful; and
cause an indication to be provided that: (i) the registration for one of the PS and CS domains is successful but that the registration for the other one of the PS and CS domains is unsuccessful and (ii) a timer is to be actuated so as to prevent another request for the combined registration for the PS domain and the CS domain for a predetermined period of time following the initial request.

21. An apparatus according to claim 20 wherein the at least one memory and the computer program code are configured to, with the at least one processor, cause the apparatus to receive the indication that the registration for one of the PS and CS domains is successful but that the registration for the other one of the PS and CS domains is unsuccessful by receiving the indication that the registration for the PS domain is successful but that the registration for the CS domain is unsuccessful and by receiving an indication that the registration for the CS domain is unsuccessful as a result of CS domain congestion.

22. An apparatus according claim 20 wherein the indication that the timer is to be actuated includes a value for the timer that defines the predetermined period of time.

23. An apparatus according to claim 20 wherein the apparatus is embodied by an access point.

24. An apparatus according to claim 20 further comprising a communication interface configured to communicate with the at least one processor.
